(19) United States
(12) Patent Application Publication
(10) Pub. No.: US 2014/0211170 A1
(43) Pub. Date: Jul. 31, 2014

(54) ILLUMINATOR AND IMAGE DISPLAY DEVICE

(71) Applicant: Panasonic Corporation, Osaka (JP)

(72) Inventors: Hiroshi KITANO, Hyogo (JP); Takashi IKEDA, Osaka (JP); Manabu OKUNO, Osaka (JP); Takaaki TANAKA, Osaka (JP)

(73) Assignee: Panasonic Corporation, Osaka (JP)

(21) Appl. No.: 14/165,195

(22) Filed: Jan. 27, 2014

(30) Foreign Application Priority Data
Jan. 28, 2013 (JP) 2013-012916
Dec. 6, 2013 (JP) 2013-252890

(51) Int. Cl. F21V 9/16; G03B 21/20

(52) U.S. Cl. CPC F21V 9/16; G03B 21/204
USPC 353/31; 362/84

(57) ABSTRACT

An illuminator 10 according to one embodiment includes laser light sources 22 and 28 for emitting laser light, at least two phosphor substrates 16 with phosphors 112, 114 and 116 arranged thereon which can be excited by laser light to emit fluorescent light, and an optical element 62 for spatially combining together the fluorescent light emitted from the at least two phosphor substrates 16.

### BACKGROUND

1. Technical Field

The present disclosure relates to an illuminator using a phosphor, and an image display device having the same.

2. Description of the Related Art

Conventional projectors often use, as a light source, a high-brightness high-pressure mercury lamp. However, high-pressure mercury lamps have short operating lifetime and are troublesome to maintain, and it has been proposed to use solid-state light sources, such as light emitting diodes (LEDs) and laser light sources, instead of high-pressure mercury lamps, as a light source of an image display device.

Laser light sources have longer operating lifetime than high-pressure mercury lamps, and also have a high directionality, hence a high light efficiency. Moreover, with their monochromaticity, a wider color reproduction range can be realized. On the other hand, laser light, due to its high coherence, may have speckle noise, thus deteriorating the image quality.

With LED light sources, although there is no speckle noise, it is difficult to realize a high-brightness image display device for reasons such as the light source having a large light-emitting area, or the green LED having a low light-emitting efficiency.

In order to solve these problems, light source devices have been proposed for use in image display devices, where a phosphor is made to emit light using LED light or laser light as excitation light (e.g., Japanese Laid-Open Patent Publication No. 2011-013313).

### SUMMARY

The present disclosure provides an illuminator capable of high-brightness optical output using a phosphor, and an image display device using the same.

An illuminator according to one embodiment of the present disclosure includes: a laser light source for emitting laser light; at least two phosphor substrates each including a phosphor arranged thereon which can be excited by laser light to emit fluorescent light; and an optical element for spatially combining together the fluorescent light emitted from the at least two phosphor substrates.

With the device according to one embodiment of the present disclosure, it is possible to use a laser light source and a phosphor to output high-brightness fluorescent light.

### BRIEF DESCRIPTION OF THE DRAWINGS

FIG. 1 is a diagram showing an image display device according to an embodiment.

FIG. 2(a) and FIG. 2(b) are diagrams showing a phosphor wheel of the image display device according to the embodiment.

FIG. 3(a) and FIG. 3(b) are diagrams showing a filter wheel of the image display device according to the embodiment.

FIG. 4 is a graph showing the relationship between the laser light intensity and the phosphor conversion efficiency and the phosphor surface temperature according to the embodiment.

FIG. 5 is a graph showing the relationship between the laser light intensity and the overall efficiency of the illuminator according to the embodiment.

FIG. 6 is a graph showing the relationship between the laser light spot diameter and the overall efficiency of the illuminator according to the embodiment.

FIG. 7 is a diagram showing an image display device according to an embodiment.

FIG. 8 is a diagram showing the image display device according to the embodiment.

FIG. 9 is a diagram showing the image display device according to the embodiment.

FIG. 10 is a diagram showing an image display device according to an embodiment.

### DETAILED DESCRIPTION

An embodiment of the present disclosure will now be described with reference to the drawings. Note however that unnecessarily detailed descriptions may be omitted. For example, detailed descriptions on what are well known in the art or redundant descriptions on substantially the same configurations may be omitted. This is to prevent the following description from becoming unnecessarily redundant, to make it easier for a person of ordinary skill in the art to understand. Note that the present inventors provide the accompanying drawings and the following description in order for a person of ordinary skill in the art to sufficiently understand the present disclosure, and they are not intended to limit the subject matter set forth in the claims.

With projectors, as opposed to many other phosphor-utilizing products, the light source needs to be a point light source, and the light density of the point light source needs to be 10 W/mm² or more, for example. Such a light density is greater those of the fluorescent output of other phosphor-utilizing products by an order of magnitude or more.

The present inventors made an in-depth study for obtaining high-brightness output light with an illuminator where a phosphor is made to emit light using laser light as excitation light. In order to realize high-power light needed for a projector with an illuminator where a phosphor is made to emit light using laser light as excitation light, one may consider illuminating high-power laser light onto a fluorescent plate. However, when high-power laser light is illuminated onto a phosphor, the fluorescent output rather decreased. While a physical phenomenon called “thermal quenching” is known in the technical field of phosphors, where the fluorescent output decreases as the temperature increases, it has not been known specifically which parameters are significantly involved in the decrease of the fluorescent output when a phosphor is made to emit light using laser light as excitation light. Thus, with an illuminator where a phosphor is made to emit light using laser light as excitation light, it has been difficult to obtain fluorescent light of a high brightness.

As the present inventors repeatedly studied an illuminator where a phosphor is made to emit light using laser light as excitation light, it was found that the light density of laser light was greatly involved as a factor for decreasing the fluorescent output. Since the light density needed for many other conventional phosphor-utilizing products was smaller by an order of magnitude, it has not been necessary to take into consideration problems such as those described above. Also with projectors using an LED as the excitation light source, the density of light to be illuminated onto a phosphor is small, and it has not been necessary to take into consideration problems such as those described above. Problems such as those described above were recognized for the first time in relation to studies on projectors where a phosphor is made to emit light using laser light as excitation light.

The studies by the present inventors also revealed that in phosphor wavelength conversion, about 30% to about 50% of laser light (excitation light) incident on the phosphor is converted to heat. For example, where the laser light intensity is 100 W, a heat of about 30 W to about 50 W was generated on the phosphor wheel. In order to reduce the influence of thermal quenching, it is necessary to suppress the amount of heat generation per phosphor wheel.

An embodiment of the present disclosure provides an illuminator capable of outputting fluorescent light of a high brightness using a laser light source and a phosphor, and an image display device using the same.

Although a projector is used as an example of the image display device in the following description of the embodiment, the embodiment is not limited thereto but the image display device may be a television or any other display devices.

### Embodiment

An image display device according to the present embodiment is an image display device including one light modulator element for modulating light in accordance with an image signal, the image display device including: a laser light source for outputting laser light; two phosphor substrates each including a phosphor arranged thereon which phosphor can be excited by laser light to emit fluorescent light; and an optical element for spatially combining together the fluorescent light emitted from those two phosphor substrates.

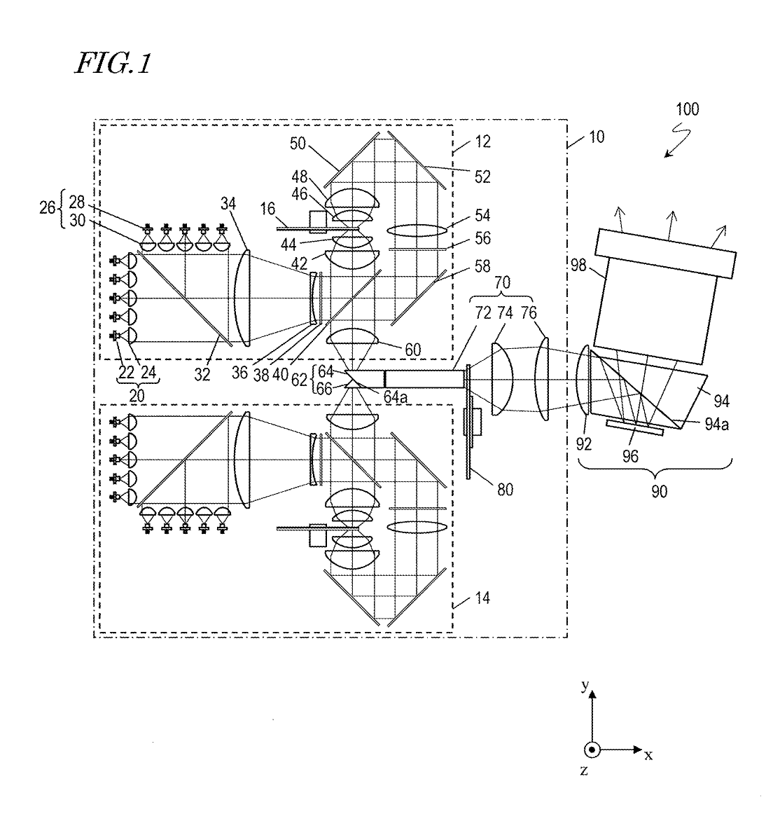

FIG. 1 is a diagram showing a configuration of an image display device 100 according to the present embodiment. In this example, the image display device 100 is a projector.

The image display device 100 includes an illuminator 10, an image generating section 90, and a projection lens 98 for projecting image light generated by the image generating section 90 onto a screen (not shown).

The illuminator 10 includes a first light source device 12, a second light source device 14, a light beam combining element 62 for spatially combining together light emitted from the first and second light source devices 12 and 14, a light guide optical system 70 for guiding the combined light beam to the image generating section 90, and a filter wheel 80.

The first light source device 12 and the second light source device 14 are of the same components, except that those components are arranged in line symmetry with respect to each other. Therefore, only the first light source device 12 will be described below for the sake of simplicity.

A first laser module 20 and a second laser module 26 include semiconductor laser elements 22 and semiconductor laser elements 28 arranged in a 5×5 matrix pattern for outputting blue laser light having a wavelength of 450 nm, and a lens 24 and a lens 30 provided for each of the semiconductor laser elements. The lens 24 and the lens 30 have the function of condensing light emitted from the semiconductor laser element with a divergence angle into a collimated light beam.

Emitted light from the laser modules are spatially combined together by a mirror 32. While the semiconductor laser element of each of the first and second laser modules are arranged equi-distantly, the positions of the laser modules are adjusted so that light emitted from the first laser module 20 and light emitted from the second laser module 26 are incident at different positions on the mirror 32. In view of this, the mirror 32 is AR-coated to be highly transmissive to laser light over an area thereof where light emitted from the first laser module 20 is incident, and is mirror-coated to be highly reflective to laser light over an area thereof where light emitted from the second laser module 26 is incident.

Laser light combined by the mirror 32 is superposed while being condensed by a lens 34. Light having been condensed through the lens 34 passes through a lens 36 and a diffusion plate 38 before being incident on a dichroic mirror 40. The lens 36 has the function of turning light, which has been condensed by the lens 34, back into a collimated light beam, and the diffusion plate 38 has the function of reducing the coherence of laser light and adjusting the condensation of laser light.

The dichroic mirror 40 is a color combining element whose cut-off waveform is set to be about 480 nm. Therefore, light, which has been generally collimated by the lens 36, is reflected by the dichroic mirror 40 to be illuminated onto a phosphor wheel 16.

In order to reduce the spot size of the laser light condensed onto the phosphor wheel 16 so as to improve the light efficiency, the laser light to be illuminated onto the phosphor wheel 16 is condensed by lenses 42 and 44.

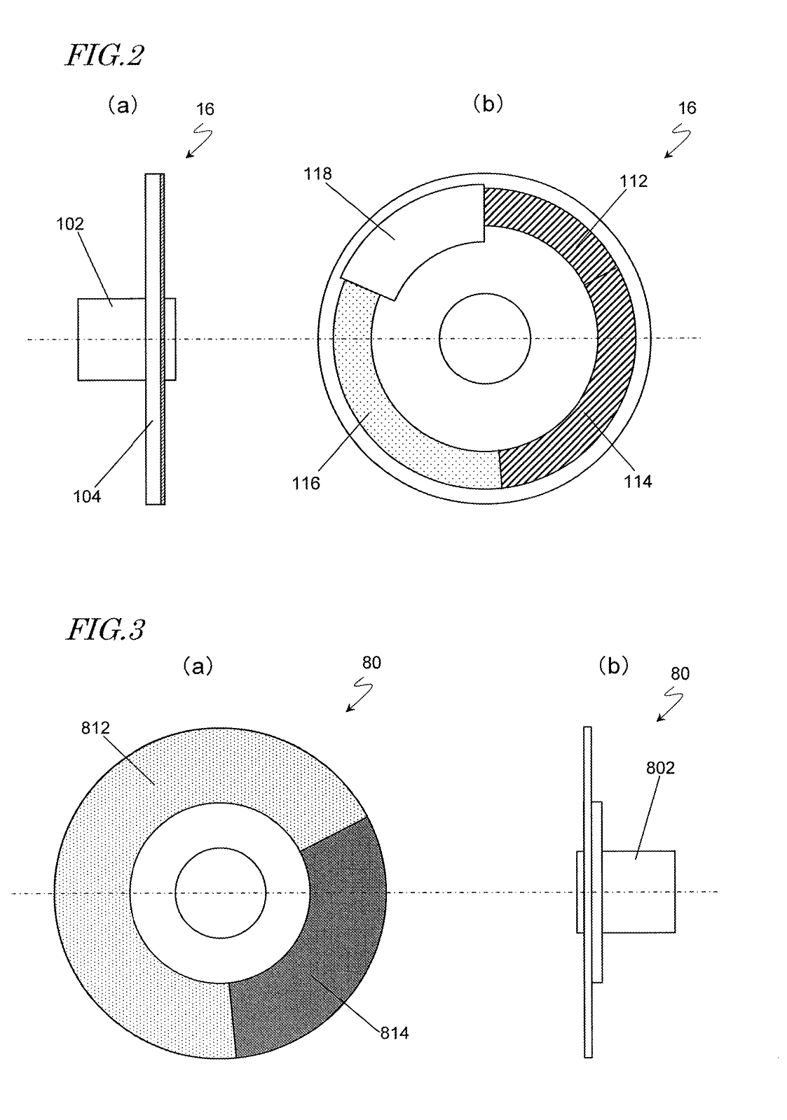

FIG. 2 is a diagram showing a configuration of the phosphor wheel (phosphor substrate) 16, wherein FIG. 2(a) is a plan view of the phosphor wheel 16 as seen from the same side as FIG. 1, and FIG. 2(b) is a side view of the phosphor wheel 16 of FIG. 2(a) as seen from the right side.

The phosphor wheel 16 includes a phosphor area 112 and a phosphor area 114 coated with a phosphor that emits yellow light whose dominant wavelength is 570 nm in response to light having a wavelength of 450 nm, a phosphor area 116 coated with a phosphor that emits green light whose dominant wavelength is 552 nm in response to light having a wavelength of about 450 nm, and a cut-out area 118 which is cut out. The phosphor area 112 and the phosphor area 114 are coated with the same yellow phosphor. Each phosphor is applied, while being mixed with a silicon resin, to a width of 4 mm and a thickness of 150 microns, for example.

These phosphors are applied on an aluminum substrate 104 having a diameter of 65 mm whose surface is coated to be highly reflective, and the aluminum substrate 104 is attached to a motor 102 to be spun (e.g., 10800 rpm).

The phosphor wheel 16 includes three phosphor areas 112, 114 and 116 and one cut-out area 118, which together correspond to one image frame (e.g., 1/60 sec). That is, over one frame, light illuminated onto the phosphor wheel 16 is divided in time into a first segment to be illuminated onto the phosphor area 112, a second segment onto the phosphor area 114, a third segment onto the phosphor area 116, and a fourth segment onto the cut-out area 118. The switching between the first to fourth segments by the phosphor wheel 16 is synchronized between the first light source device 12 and the second light source device 14 (FIG. 1).

Referring back to FIG. 1, light illuminated onto the phosphor wheel 16 during the first, second and third segments is converted to yellow and green light and reflected off the phosphor wheel 16. These yellow and green fluorescent light are collimated by the lenses 44 and 42 and return to the dichroic mirror 40 to pass through the dichroic mirror 40.

On the other hand, during the fourth segment, light illuminated onto the phosphor wheel 16 passes through the cut-out area 118 of the phosphor wheel 16. Mirrors 50, 52 and 58 are arranged along the optical path so as to return the light, which has passed through the phosphor wheel 16, back to the dichroic mirror 40. Since the light having passed through the phosphor wheel 16 is condensed by the lenses 42 and 44, it is collimated by lenses 46 and 48, and also a lens 54 for relaying the light over the extended optical path and a diffusion plate 56 for further reducing the coherence of laser light are arranged along the optical path.

Light, which has passed through the phosphor wheel 16 to be relayed over the optical path to return to the dichroic mirror 40, is reflected by the dichroic mirror 40. Thus, the optical path of light having passed through the phosphor wheel 16 and the optical path of light having been reflected thereby are spatially combined together by the dichroic mirror 40.

Light which has been obtained by combining by the dichroic mirror 40 is condensed by a lens 60 to be emitted from the first light source device 12. Similar to the first light source device 12, light is emitted also from the second light source device 14.

The phosphor wheel 16 in the first light source device 12 and the phosphor wheel in the second light source device 14 have the same specifications, and light having the same color characteristics are emitted from the light source devices 12 and 14.

Light emitted from the first light source device 12 and the second light source device 14 are spatially combined together by the light beam combining element 62. The light beam combining element 62 includes trapezoidal prisms 64 and 66. Light emitted from the first light source device 12 is incident on the trapezoidal prism 64. Light incident on the trapezoidal prism 64 is reflected by a surface 64a, which is a slope having an angle of 45 degrees, and the light is then repeatedly totally reflected inside the trapezoidal prism 64 to be incident on a rod integrator 72. Similarly, light emitted from the second light source device 14 is incident on the trapezoidal prism 66 to be reflected by a slope having an angle of 45 degrees, and the light is then repeatedly totally reflected inside to be incident on the rod integrator 72. The trapezoidal prism 64 and the trapezoidal prism 66 have the same shape, and are arranged so that their 45-degree slopes oppose each other so as to combine, and extract in the same direction, light from the respective light source devices.

The exit surface size of each of the trapezoidal prisms 64 and 66 is just one half the input surface size of the rod integrator 72, and by arranging the trapezoidal prism 64 and the trapezoidal prism 66 to be in close contact with each other as shown in FIG. 1 and by arranging the prism exit surface and the input surface of the rod integrator 72 to be close to each other, light incident on the trapezoidal prism 64 and the trapezoidal prism 66 can be efficiently coupled to the rod integrator.

Light from the light source devices incident on the rod integrator 72 have their illuminances uniformized through the rod integrator 72 and then pass through the filter wheel 80.

FIG. 3 is a diagram showing a configuration of the filter wheel 80. FIG. 3(b) is a plan view of the filter wheel 80 as seen from the same side as FIG. 1, and FIG. 3(a) is a side view of the filter wheel 80 of FIG. 3(b) as seen from the left side.

The filter wheel 80 includes a visible light passing area 812, which is an area formed by a glass substrate that is highly transmissive over the entire visible range, and a color filter area 814, which is an area formed by a color filter substrate that is highly reflective to light having a wavelength less than 600 nm and highly transmissive to light within the visible range having a wavelength of 600 nm or more. The filter wheel 80 is attached to a motor 802 to be spun. Note that the glass substrate and the color filter substrate may be formed separately or may be formed as an integral member.

The phosphor wheel 16 and the filter wheel 80 are spun synchronously at the same number of revolutions. That is, the filter wheel 80 is configured to include the visible light passing area 812 and the color filter area 814, which together correspond to one frame (e.g., 1/60 sec).

Moreover, the timing is adjusted so that yellow fluorescent light emitted from the phosphor area 114 in response to laser light illuminated onto the phosphor area 114 of the phosphor wheel 16 is incident on the color filter area 814 of the filter wheel 80. Thus, the phosphor area 114 and the color filter area 814 have the same segment angle. Since the color filter area 814 removes light less than 600 nm, the short wavelength component is removed from the yellow fluorescent light emitted from the phosphor area 114, and the light becomes red light to be emitted from the filter wheel 80.

Light emitted from the filter wheel 80 is relayed by lenses 74 and 76 and becomes the output light from the illuminator 10 to be incident on the image generating section 90. As described above, the illuminator 10 includes various optical components such as lenses, mirrors, and the like.

The image generating section 90 includes a lens 92, a total reflection prism 94, and a single DMD (Digital Mirror Device) 96. The lens 92 has the function of forming an image of light of the exit surface of the rod integrator 72 on the DMD 96. Light, which has been incident on the total reflection prism 94 through the lens 92, is reflected by a surface 94a to be guided to the DMD 96. The DMD 96 controlled by a control section (not shown) in accordance with the timing between different color light incident respectively on a plurality of mirrors and in accordance with the input image signal. Light, which has been modulated by the DMD 96, passes through the total reflection prism 94 and is guided to the projection lens 98. The projection lens 98 projects the temporally-combined image light onto a screen (not shown) outside the device.

In the present embodiment, the DMD 96, which is a light modulator element, is a DMD having a diagonal size of 0.67 inch, for example, and the F number of the projection lens 98 is 1.7, for example.

In the present embodiment, the illuminator 10 outputs light of four colors, i.e., red light, green light, blue light and yellow light, which are switched from one to another over time. Herein, red light is not generated from a red phosphor, but is generated by removing the short wavelength component from yellow fluorescent light from a yellow phosphor. That is, red light and yellow light are generated from the same yellow phosphor, and a cerium-activated garnet structure phosphor (Y3AlSO12:Ce3+) was used in the present embodiment. On the other hand, as the phosphor for generating green light, another cerium-activated garnet structure phosphor (Lu3Al5O12:Ce3+) having a different composition was used.

While it is necessary to increase the laser light intensity for exciting the phosphor in order to obtain a high-brightness illuminator, an increase in the laser light intensity decreases the phosphor efficiency and also increases the phosphor temperature. In view of this, in the present embodiment, two phosphor substrates are provided so as to suppress the heat generation per phosphor substrate, thereby minimizing this influence and obtaining high-brightness and highly-efficient illumination. Specific parameters of the optical system will now be described.

Lu3Al5O12:Ce3+ is a phosphor having a superior thermal quenching property to that of Y3Al5O12:Ce3+. Therefore, parameters of laser light to be incident on the phosphor were determined based on the properties of the yellow phosphor (Y3Al5O12:Ce3+).

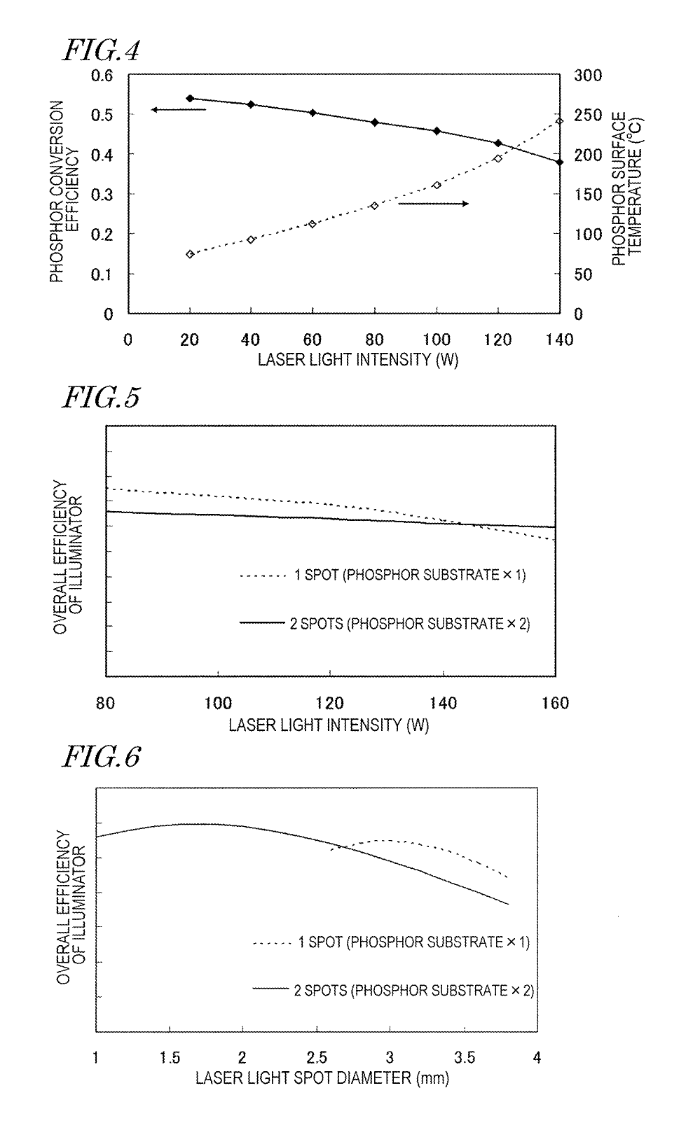

FIG. 4 shows, for the yellow phosphor used in the present embodiment, the relationship between the laser light intensity and the wavelength conversion efficiency and the phosphor surface temperature of the phosphor. As an experimental condition, the yellow phosphor is applied, while being mixed with a silicon resin, to a width of 4 mm and a thickness of 150 microns over the entire circumference near the outer perimeter of a circular aluminum substrate having a diameter of 65 mm whose surface is coated to be highly reflective. The circular aluminum substrate is attached to a spin motor and is spun at 10800 rpm, and the temperature of the atmosphere around the circular aluminum substrate is 60° C. The laser light spot diameter on the phosphor is 1.6 mm. The spatial intensity profile of the laser light spot on the phosphor is generally a Gaussian shape, and the spot diameter as used herein represents the full width at 13.5% of the peak intensity.

In order to ensure the long-term reliability of the silicon resin, the phosphor temperature can be set to be approximately 200° C. or less, for example, but in order to further enhance the reliability, the phosphor temperature can be set to be approximately 150° C. or less, for example. In view of this, referring to FIG. 4, in order to efficiently use the yellow phosphor under an environment where the atmosphere temperature is 60° C., the laser light intensity is set to be approximately 120 W or less, and more preferably approximately 100 W or less, for example. In the present embodiment, laser light having a light power of 80 W was made to be incident on the phosphor wheel 16 with a spot diameter of 1.6 mm, as combined light obtained by a total of 50 semiconductor laser elements. That is, with the first light source device 12 and the second light source device 14, laser light of a total of 160 W were incident on two phosphor wheels 16.

With an optical configuration of the present embodiment where two phosphor substrates are used, since the light beam combining element is needed, there is a slight optical loss due to the addition of the light beam combining element, as compared with an optical configuration where only one phosphor substrate is used. However, since the laser light intensity per phosphor substrate can be reduced to half, there is a greater advantageous effect, whereby the decrease in phosphor efficiency due to heat generation is suppressed, for areas where the laser light intensity is high.

FIG. 5 shows the relationship between the overall efficiency of the illuminator 10 (light efficiency of optical system×wavelength conversion efficiency of yellow phosphor) and the laser light intensity in a case where one phosphor substrate (the phosphor wheel 16) is used and in a case where two phosphor substrates are used. For an area where the total intensity of the laser light incident on the phosphor substrate(s) exceeds 140 W, it is better, also in view of the overall efficiency, to use two phosphor substrates so as to reduce to half the intensity of laser light to be incident on one phosphor substrate. Since laser light of a total of 160 W is incident in the present embodiment, the efficiency is higher with the use of two phosphor substrates.

FIG. 6 shows the relationship between the laser light spot diameter on the phosphor and the overall efficiency of the illuminator 10 when laser light of a total of 160 W is incident. In order to improve the light efficiency by decreasing the etendue, the spot diameter of laser light to be illuminated onto the phosphor wheel 16 is preferably small. On the other hand, if the spot diameter of the laser light decreases, the light density on the phosphor increases, thereby reducing the wavelength conversion efficiency of the phosphor. Therefore, the appropriate spot size is determined depending on the laser light intensity so as to maximize the product between the light efficiency and the wavelength conversion efficiency of the phosphor, for example.

In the present embodiment, taking the size of the DMD 96 and the F number of the projection lens 98 into consideration, a spot diameter of 1.6 mm is optimal, and this value was employed. In a configuration where two phosphor substrates are used, since light beams from the two light source devices are combined together and used, the optimal spot diameter is smaller than that in a configuration where only one phosphor substrate is used.

In the present embodiment, two light source devices 12 and 14 are provided in one illuminator 10, wherein each of the light source devices uses a phosphor substrate coated with a cerium-activated garnet structure phosphor having a high light-emitting efficiency and a superior thermal quenching property. Moreover, the intensity and the spot diameter of laser light to be incident on the phosphor substrate are optimized, thereby realizing a higher efficiency.

By using such an optical configuration, it is possible to improve the light power while suppressing the increase in the phosphor temperature, and it is therefore possible to realize a high-brightness, long-life illuminator.

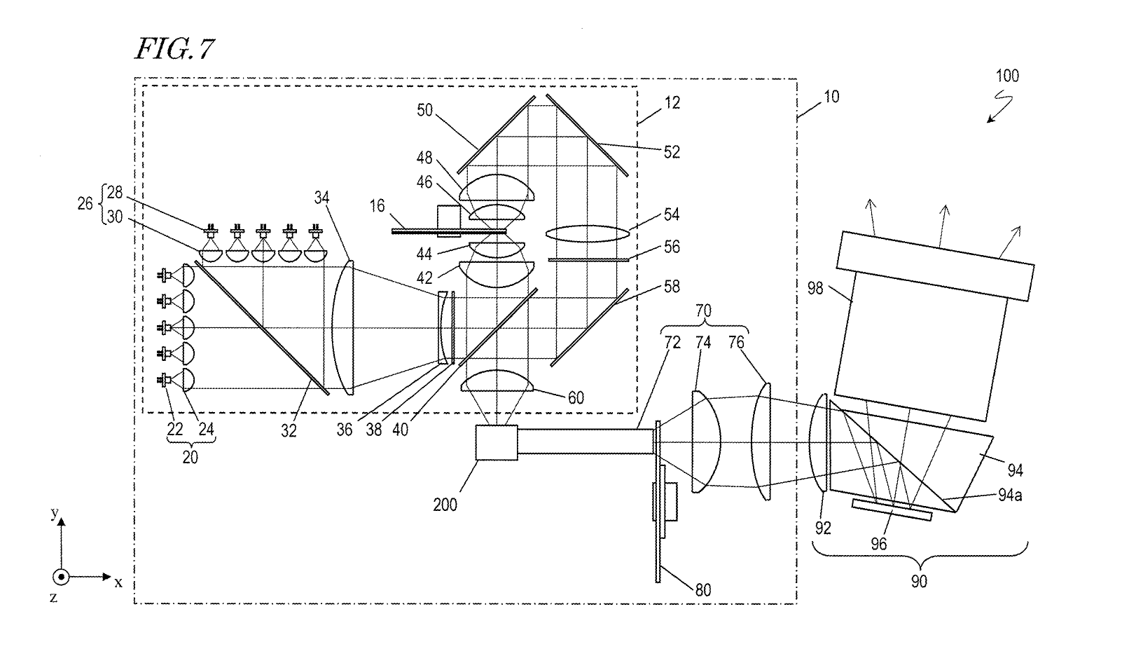

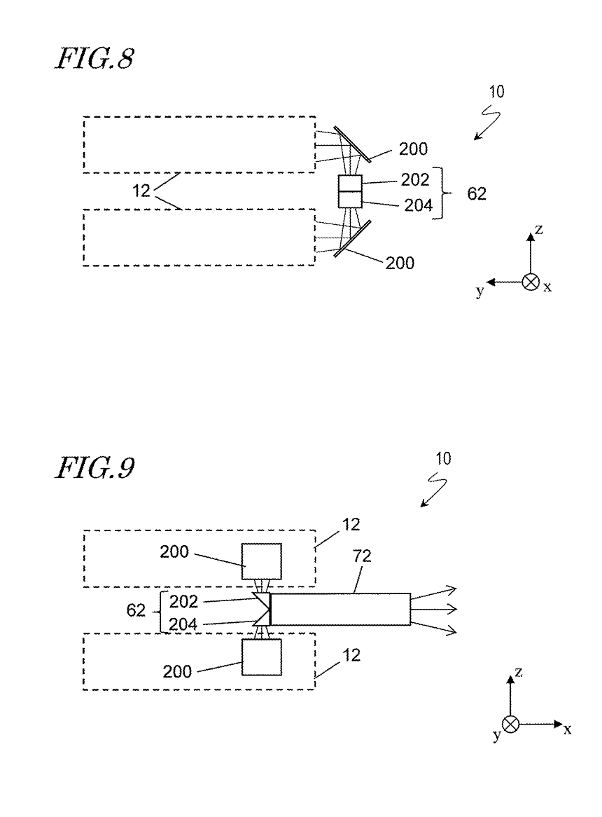

Note that while the two light source devices 12 and 14 are arranged side by side (arranged along the xy plane in the figure) in the example shown in FIG. 1, such a plurality of light source devices may be arranged next to each other in the height direction (the z direction in the figure). FIGS. 7 to 9 are diagrams showing an illuminator 10 in which two light source devices 12 are arranged next to each other in the height direction (z direction). FIG. 8 is a side view showing the illuminator 10 as seen in the x direction from the left side of the plan view of FIG. 7, and FIG. 9 is a side view of the illuminator 10 as seen in the y direction from the lower side of the plan view of FIG. 7. Note that although FIG. 7 shows only one light source device 12 because the two light source devices 12 are on top of each other in the plan view of FIG. 7, there are actually two light source devices 12.

The operation from when laser light is emitted from the laser modules 20 and 26 to when light condensed by the lens 60 is emitted from the light source device 12 is the same as that of the light source device 12 shown in FIG. 1, and therefore will not be described below.

In the example shown in FIGS. 7 to 9, light emitted from the two light source devices 12 each change its direction to the z direction through a mirror 200, and the light are incident on the light beam combining element 62 to be spatially combined together. That is, emitted light travels in the z direction perpendicular to the plane (the xy plane), on which the laser modules 20 and 26 and the phosphor wheel 16 in the upper light source device 12 are arranged, so as to be incident on the light beam combining element 62. Also, emitted light travels in the z direction perpendicular to the plane (the xy plane), on which the laser modules 20 and 26 and the phosphor wheel 16 in the lower light source device 12 are arranged, so as to be incident on the light beam combining element 62.

The light beam combining element 62 includes triangular prisms 202 and 204 in this example. The emitted light from the upper light source device 12 is incident on the triangular prism 202. Light incident on the triangular prism 202 is reflected by a slope having an angle of 45 degrees and is then incident on the rod integrator 72. Similarly, the emitted light from the lower light source device 12 is incident on the triangular prism 204 to be reflected by a slope having an angle of 45 degrees, and is then incident on the rod integrator 72.

The operation from when light is incident on the rod integrator 72 to when an image is projected onto the screen is the same as that of the image display device 100 shown in FIG. 1, and therefore will not be described below.

Thus, by arranging a plurality of light source devices 12 next to each other in the height direction, it is possible to reduce the size of the image display device 100 in the xy direction.

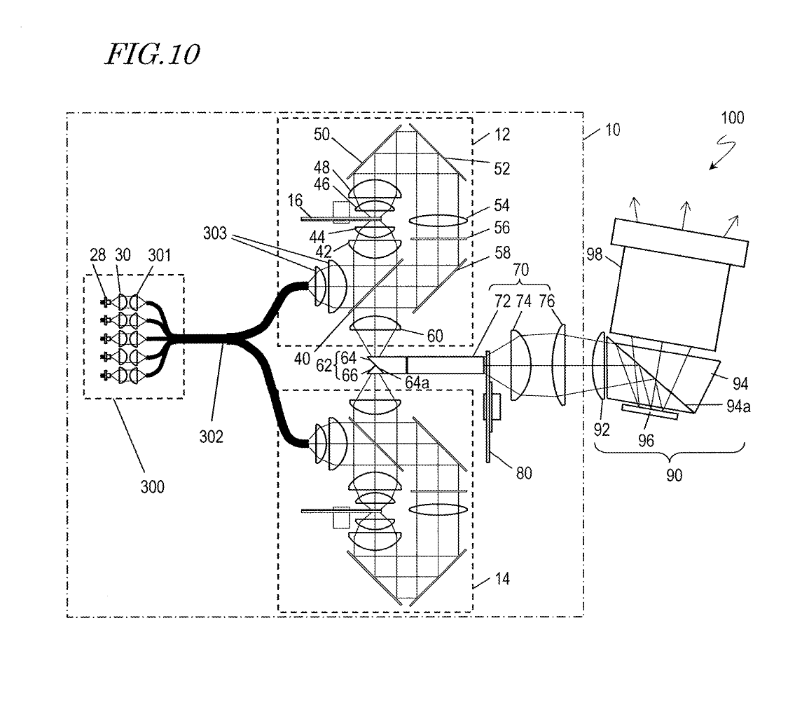

While the two light source devices 12 and 14 each include the laser modules 20 and 26 in the example shown in FIG. 1, laser light emitted from a single laser module may be distributed between the two light source devices 12 and 14. FIG. 10 shows an image display device 100 in which laser light emitted from a single laser module 300 is distributed between two light source devices 12 and 14.

The laser module 300 includes a plurality of semiconductor laser elements 28, the lens 30, and a lens 301. By placing a plurality (e.g., 50) of semiconductor laser elements all in one location, it is possible to increase the power of the laser light.

The lens 30 and the lens 301 make laser light, which has been emitted from the semiconductor laser element 28, incident on an optical fiber 302. The optical fiber 302 is a fiber bundle, for example, and even if the power of the individual semiconductor laser element 28 is low, it is possible to obtain high-power laser light by coupling the individual laser light to the optical fiber 302. The optical fiber 302 functions as a distribution element for distributing laser light emitted from a single laser module 300 between the two light source devices 12 and 14. Note that there may be two or more laser modules 300, also in which case laser light can be distributed between the light source devices 12 and 14 by making laser light travel from the two or more laser modules 300 to be incident on the optical fiber 302.

The laser light, which has been distributed between and incident on the light source devices 12 and 14, is generally collimated by a lens 303 and is reflected by the dichroic mirror 40 to be illuminated onto the phosphor wheel 16. That is, the optical fiber 302 distributes laser light emitted from one laser module 300 between two phosphor wheels 16, and distributed laser light are incident respectively on the two phosphor wheels 16.

The operation from when light is incident on the phosphor wheel 16 to when an image is projected onto the screen is the same as that of the image display device 100 shown in FIG. 1, and therefore will not be described below.

Using a single light source unit as shown in FIG. 10, it is possible to facilitate the maintenance of the image display device 100. Even if high-power laser light is emitted from the laser module 300, it is distributed between and incident on two phosphor wheels 16, and it is therefore possible to obtain high-brightness illumination while maintaining a high conversion efficiency by suppressing the heat generation per phosphor wheel.

### Other Embodiments

While a laser module formed by semiconductor laser elements arranged in a 5×5 matrix pattern has been illustrated in the embodiment described above, the present disclosure is not limited to the number of semiconductor laser elements and the arrangement thereof, and they may be determined appropriately depending on the light intensity per semiconductor laser element and the desired power for the light source device. The wavelength of the laser light is not limited to 450 nm, and one may use a violet semiconductor laser element for outputting light of 405 nm, or a semiconductor laser element for outputting ultraviolet light of 400 nm or less.

While a configuration where a cerium-activated garnet structure phosphor is excited by blue laser light to emit light whose dominant wavelengths are yellow and green has been illustrated in the embodiment described above, a phosphor for emitting light whose dominant wavelength is red or blue green may be used.

While a configuration using a 0.67-inch single-plate DMD has been illustrated in the embodiment described above, a DMD of a different size may be used. An optical configuration using a three-plate light modulator element may be employed. The F number of the optical system is not particularly limited to that of the example described above.

Since the optimal value of the laser light spot diameter on the phosphor slightly varies depending on the light modulator element size, the F number of the optical system, the type of phosphor, and the laser light intensity to be incident on the phosphor, optimal values may be determined as necessary, based on the parameter optimization method shown in the embodiment described above, depending on the specifications of the image display device.

(Summary)

As described above, the illuminator 10 according to one embodiment of the present disclosure includes the laser light sources 22 and 28 for emitting laser light, at least two phosphor substrates 16 with the phosphors 112, 114 and 116 arranged thereon which can be excited by laser light to emit fluorescent light, and the optical element 62 for spatially combining together the fluorescent light emitted from the at least two phosphor substrates 16.

In one embodiment, the phosphors 112, 114 and 116 include a cerium-activated garnet structure phosphor, for example.

In one embodiment, the peak intensity of laser light to be incident on each of the phosphor substrates 16 is 60 W or more and 120 W or less, for example.

In one embodiment, the spot diameter of laser light to be incident on each of the phosphor substrates 16 is 1.2 mm or more and 2.00 mm or less, for example.

In one embodiment, fluorescent light is incident on the optical element 62 in a direction perpendicular to the plane on which the laser light sources 22 and 28 and the phosphor substrate 16 are arranged, for example.

In one embodiment, the illuminator 10 may further include a distribution element for distributing laser light emitted from the laser light source 28 between at least two phosphor substrates 16, in which case the laser light is distributed between and incident on the at least two phosphor substrates 16.

The image display device 100 according to one embodiment of the present disclosure includes the illuminator described above, the light modulator element 96 for modulating the fluorescent light emitted from the illuminator 10, and the projection optical system 98 for projecting an image emitted from the light modulator element 96 onto a screen.

Embodiments have been described above as an illustration of the technique of the present disclosure. The accompanying drawings and the detailed description are provided for this purpose. Thus, elements appearing in the accompanying drawings and the detailed description include not only those that are essential to solving the technical problems set forth herein, but also those that are not essential to solving the technical problems but are merely used to illustrate the technique disclosed herein. Therefore, those non-essential elements should not immediately be taken as being essential for the reason that they appear in the accompanying drawings and/or in the

### DETAILED DESCRIPTION

The embodiments above are for illustrating the technique disclosed herein, and various changes, replacements, additions, omissions, etc., can be made without departing from the scope defined by the claims and equivalents thereto.

The present technique is applicable to image display devices for emitting high-brightness light using phosphors. Specifically, the present technique is applicable to televisions, and the like, as well as projectors.

This application is based on Japanese Patent Applications No. 2013-012916 filed on Jan. 28, 2013 and No. 2013-252890 filed on Dec. 6, 2013, the entire contents of which are hereby incorporated by reference.

What is claimed is:

1. An illuminator comprising:
a laser light source for emitting laser light;
at least two phosphor substrates each including a phosphor arranged thereon which phosphor can be excited by laser light to emit fluorescent light; and
an optical element for spatially combining together the fluorescent light emitted from the at least two phosphor substrates.

2. The illuminator of claim 1, wherein the phosphor includes a cerium-activated garnet structure phosphor.

3. The illuminator of claim 1, wherein a peak intensity of the laser light to be incident on each of the phosphor substrates is 60 W or more and 120 W or less.

4. The illuminator of claim 1, wherein a spot diameter of the laser light to be incident on each of the phosphor substrates is 1.2 mm or more and 2.00 mm or less.

5. An image display device comprising:
the illuminator of claim 1;
a light modulator element for modulating the fluorescent light emitted from the illuminator; and
a projection optical system for projecting an image emitted from the light modulator element onto a screen.
